(19) United States
(12) Patent Application Publication
(10) Pub. No.: US 2025/0264372 A1
(43) Pub. Date: Aug. 21, 2025

(54) APPARATUS AND METHOD FOR TESTING AN ASTIGMATIC OPTICAL TEST OBJECT

(71) Applicant: Trioptics GmbH, Wedel (DE)

(72) Inventors: Philipp BEER, Wedel (DE); Johannes HINRICHS, Wedel (DE); Sergio BAYON, Wedel (DE); Jan-Hinrich EGGERS, Wedel (DE)

(73) Assignee: Trioptics GmbH, Wedel (DE)

(21) Appl. No.: 19/058,550

(22) Filed: Feb. 20, 2025

(30) Foreign Application Priority Data
Feb. 21, 2024 (DE) 10 2024 104 842.5

(51) Int. Cl. G01M 11/02

(52) U.S. Cl. CPC G01M 11/0292; G01M 11/0221; G01M 11/0264

(57) ABSTRACT

An apparatus for testing an astigmatic optical test object is provided. The apparatus comprises an illumination device having a light source, a ring-shaped mask element and a collimation optical unit. The collimation optical unit is formed to emit to the test object light beams of the ring-shaped mask element illuminated by the light source in the form of collimated test light. The apparatus also comprises an evaluation device, which is configured to record and evaluate an image generated by the test object in response to the test light in order to determine an axis position of the test object and an optical parameter related to the axis position.

This nonprovisional application claims priority under 35 U.S.C. § 119(a) to German Patent Application No. 10 2024 104 842.5, which was filed in Germany on Feb. 21, 2024, and which is herein incorporated by reference.

### BACKGROUND OF THE INVENTION

### Field of the Invention

The invention relates to an apparatus for testing an astigmatic optical test object, to a method for testing an astigmatic optical test object and to the use of a ring-shaped mask element for testing an astigmatic optical test object.

### Description of the Background Art

Traditionally, for example, a manual or automated lensmeter can be used to characterize spectacle lenses, but only some of the relevant optical parameters of astigmatic spectacle lenses can be measured. In the case of a manual lensmeter, additional challenges may arise in terms of handling, time and accuracy, because an operator must know exactly what they are doing to ascertain, for example, a correct sphero-cylindrical glass combination; manual operation can lead to a higher cycle time, and manual lensmeters may, due to their resolution of ≥0.125 dpt, under certain circumstances not be accurate enough where an exact measurement of the refractive power is concerned. WO 2023/274822 A1, which corresponds to US 2024/0295463, which is incorporated herein by reference, and relates to the use of a ring reticle for the direction-dependent measurement of an MTF (Modulation Transfer Function).

The concepts for determining refractive powers described in the prior art do not teach how to measure, for example, waveguides, or waveguides for AR/VR applications, combined with spectacle lenses with astigmatic properties or that, and how, a ring reticle should be used to measure such waveguides with corrective properties.

### SUMMARY OF THE INVENTION

It is therefore an object of the invention to provide an improved apparatus for testing an astigmatic optical test object, an improved method for testing an astigmatic optical test object and the use of a ring-shaped mask element for testing an astigmatic optical test object.

According to examples, in particular a measurement of optical parameters of astigmatic optical test objects, for example spectacle lenses for AR/VR applications (AR=Augmented Reality; VR=Virtual Reality), using a ring-shaped mask element, which can also be referred to as ring reticle, can be advantageously made possible. For example, automatic detection of the cylindrical axis or a main axis or axis position in astigmatic optical test objects can be made possible.

An apparatus for testing an astigmatic optical test object is introduced, wherein the apparatus can comprise the following features: an illumination device having a light source, a collimation lens or collimation optical unit and a ring-shaped mask element, wherein the illumination device is configured to emit to the test object light passing through the ring-shaped mask element in the form of a collimated test light; and an evaluation device, which is configured to record and evaluate an image generated by the test object in response to the test light in order to determine an axis position of the test object.

Examples of astigmatic optical test objects may include lenses, spectacle lenses, correction lenses for NED (Near Eye Display) systems, lens systems, waveguides for AR/VR applications combined with spectacle lenses, or other optical elements. The ring-shaped mask element can also be referred to as a ring mask, ring-shaped mask or ring reticle. In order to be tested, the test object may be arranged or arrangeable between the illumination device and the evaluation device. The axis position can represent an alignment of at least one of two main axes of the astigmatic test object. The main axes can be 90 degrees offset from each other. The evaluation device may have a camera or the like or is as a camera or the like.

According to an example, the apparatus may have at least one movement device, which may be configured to cause a relative movement between the test object on the one hand and the illumination device and the evaluation device on the other, or of components of the illumination device and/or the evaluation device. Such an example offers the advantage that relevant optical parameters can also be measured in different alignments or directions.

Furthermore, the illumination device can be designed as a focusable collimator. This means that the ring-shaped mask element or ring reticle is movable along the optical axis relative to the focal plane of the collimation optical unit of the illumination device. The movement can be accomplished, for example, using a motor, such as a stepper or linear motor in combination with an encoder. This also allows the ring reticle to be imaged at a defined, finite distance.

The evaluation device may also be configured to evaluate the image in order to determine a modulation transfer function with respect to the determined axis position and, in addition or alternatively, at least one further optical parameter of the test object. Such an example offers the advantage that a plurality of relevant optical parameters or properties of astigmatic optical test objects can also be measured. In particular, such an example offers the possibility to consider a direction dependence of optical parameters in astigmatic test specimens as part of the measurement.

Further, the evaluation device may be configured to evaluate ring contours of the image which are caused by the ring-shaped mask element and the test object in order to determine the axis position based on a maximum of the sharpness along the ring contours. In this case, the evaluation device may be configured to evaluate the ring contours of the image using feature recognition or ellipsoidal feature recognition. An example of this kind offers the advantage that the axis position can be determined in a simple, accurate and reliable manner.

In addition, the evaluation device may be configured to evaluate ring contours of the image which are caused by the ring-shaped mask element and the test object in order to determine the axis position based on a maximum of the light intensity along the ring contours. Such an example offers the advantage that the axis position can be effortlessly determined, accurately and reliably.

The evaluation device can be used as a camera, e.g. as a CCD or CMOS camera and/or as a spectral or colour camera, and optionally have a variable focus. Furthermore, the evaluation device can be implemented as a camera with a telescope or as a conoscope.

Furthermore, the evaluation device may be configured to evaluate the image by incrementally changing an evaluation direction of a direction-dependent modulation transfer function in order to determine the axis position based on a maximum of the modulation transfer function. Such an example offers the advantage that the axis position can be determined accurately and reliably.

Furthermore, both the illumination device and the evaluation unit can be movable independently of each other in multiple spatial directions and/or pivotable about multiple axes. For example, the illumination device and the evaluation unit can each be attached to a goniometer.

Also provided is a method for testing an astigmatic optical test object, with the method comprising the following steps: emitting light from a light source of an illumination device through a ring-shaped mask element of the illumination device in the direction of a collimation lens or collimation optical unit, and emitting the collimated light to the test object in the form of test light; recording an image generated by the test object in response to the test light using an evaluation device; and evaluating the image using the evaluation device to determine an axis position of the test object.

The method can advantageously be carried out by means of or using an example of an apparatus specified herein for testing an astigmatic optical test object.

The method may also comprise a step of causing a relative movement between the test object on the one hand and the illumination device and the evaluation device on the other, or of components of the illumination device and/or the evaluation device, using at least one movement device. Such an example offers the advantage that relevant optical parameters can also be measured in different alignments or directions.

In this case, the causing step and the recording step can be repeatedly carried out iteratively to record a plurality of images at different alignments between the test object on the one hand and the illumination device and the evaluation device on the other. The plurality of images can be evaluated in the evaluation step. Such an example offers the advantage that the axis position can be determined accurately and reliably.

It is therefore also advantageous to use a ring-shaped mask element in an example of an apparatus specified herein for testing an astigmatic optical test object. The ring-shaped mask element or ring reticle can be realized either as a physical object or as a virtual structure, e.g. as a representation on a digital display.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic illustration of an example of an apparatus for testing an astigmatic optical test object;

FIG. 2 shows a schematic illustration of an example of an apparatus for testing an astigmatic optical test object;

FIG. 3 shows a flowchart of an example of a method for testing an astigmatic optical test object; and

FIG. 4 shows a flowchart of an example of a process for testing an astigmatic optical test object.

### DETAILED DESCRIPTION

AR and/or VR products may comprise various optical elements. Such elements are, for example, components of today's AR glasses, which are to be characterized with regard to their performance in the production process in order to offer an acceptable quality of the end product. The individual components are characterized using different parameters. For waveguides, the parameter MTF (Modulation Transfer Function or contrast transfer function) or efficiency is important; for correction lenses, the refractive power and distortion traditionally play a decisive role. Machines that are traditionally available on the market have been developed only for the measurement of individual components and their specific parameters, wherein now, in accordance with examples, in particular a measurement of all relevant components belonging to AR/VR glasses is made possible. Furthermore, the imaging quality is also of particular importance for correction lenses in AR/VR glasses, wherein it is now possible, according to examples, to measure in particular the conventional parameters for correction lenses with methods for the imaging quality of other components.

For example, a measurement of a spectacle lens, more precisely astigmatic spectacle lens, i.e. sphero-cylindrical combination with defined orientation of the two main axes, is made possible in an apparatus using a ring-shaped mask element or ring reticle. More specifically, it allows the determination of the orientation of the main axes and subsequent MTF measurement along the corresponding orientation.

It is possible to measure, for example, astigmatic spectacle lenses and other astigmatic test objects in an existing apparatus for MTF and efficiency measurement. With a ring-shaped mask element, measurements of MTF, efficiency and all relevant optical properties of such test objects can be combined. A ring reticle allows the direction in which the MTF is evaluated to be freely selected and is not limited, for example, to the sagittal or tangential plane. This allows the measurement of the orientation of the main axes to be combined with an appropriate MTF measurement. Thus, astigmatic test specimens can also be measured with such an apparatus.

Astigmatic spectacle lenses have two main axes 90 degrees apart from each other. Two different strengths work along these main axes. A typical notation of such prescription lenses is usually expressed as follows:

| Sph. [dpt] | Cyl. [dpt] | axis [°] |
|---|---|---|
| −1.00 | −0.50 | 120 |

In this example, the lens is composed of a spherical component of −1.00 dpt and an astigmatic (or cylindrical) component of −0.5 dpt. In this case, −1.50 dpt act in 120 degrees and −1.00 dpt in 30 degrees. An aim of an example is, in particular, to measure the test object with regard to its strengths and the cylinder axis and to provide an output at the end, for example similar to the abovementioned example. This means that a conventional procedure can be extended, for example, by an iteration for axis detection. The use of a ring reticle results in different detection options, as explained in more detail below.

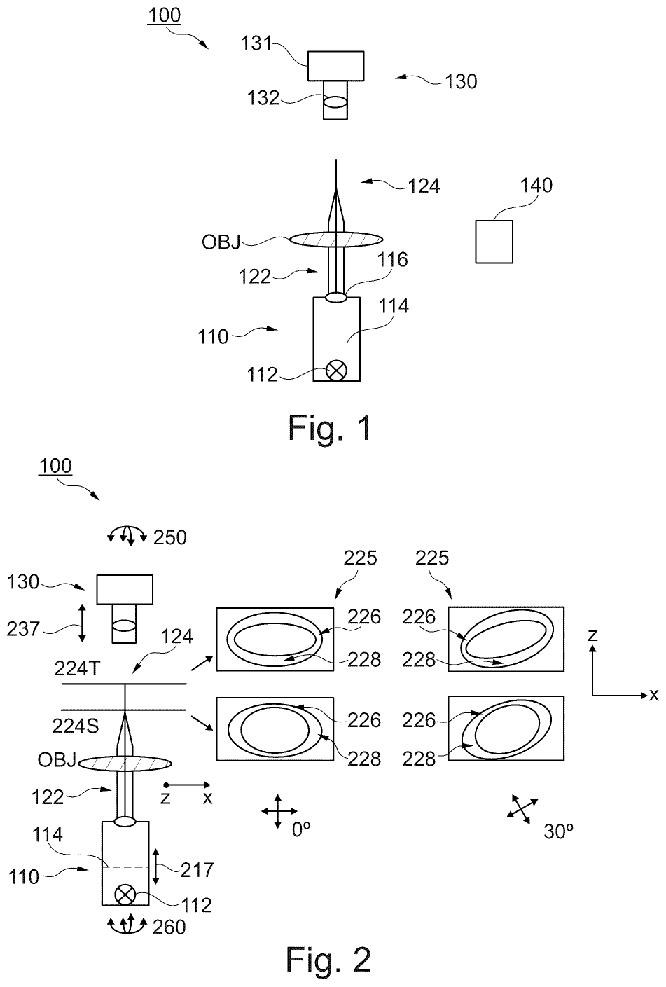

FIG. 1 shows a schematic illustration of an example of an apparatus 100 for testing an astigmatic optical test object OBJ. The apparatus 100 is configured to test the astigmatic optical test object OBJ, for example, to determine a plurality of relevant optical parameters. Such a test object OBJ is, for example, a lens, a spectacle lens, a correction lens for NED (Near Eye Display) systems, a lens system, a waveguide for AR/VR applications combined with a spectacle lens, or another optical element. In the illustration of FIG. 1, the test object OBJ is illustrated merely by way of example as a lens.

The apparatus 100 or test apparatus comprises an illumination device 110 and an evaluation device 130. Between the illumination device 110 and the evaluation device 130, the test object OBJ is arranged or arrangeable for being tested. The illumination device 110 comprises a light source 112, a ring-shaped mask element 114 or a so-called ring reticle, and a collimation optical unit or collimation lens 116. The light source 112 is configured to illuminate the ring-shaped mask element 114 and can be designed, for example, as a monochromatic or polychromatic light source and further, for example, as an incandescent lamp or white light LED. Optionally, the light source can be used in combination with an optical filter, such as a V (lambda) or photopic-eye filter. Optionally, the light source 112 and the ring reticle 114 can form a common unit, for example in the form of a display, which displays the ring reticle 114 as a virtual object or virtual structure. The ring-shaped mask element 114 is located in the focal plane of a collimation lens or collimation optical unit 116 and is imaged thereby to infinity so that the light behind the collimation lens 116 is emitted as parallel or collimated test light 122 in the direction of the test object OBJ. In addition or alternatively, the ring-shaped mask element 114 is displaceable along the optical axis of the collimation lens 116, see the double-headed arrow 217 in FIG. 2, whereby the ring-shaped structure of the mask element 114 is imagable at defined, finite distances. This allows a focus scan to be performed. The evaluation device 130 is configured to record and evaluate an image 124 generated by the test object OBJ in response to the test light 122 in order to determine at least an axis position and a related, optical parameter, e.g. with regard to the imaging quality, of the test object OBJ.

According to an example, the evaluation device 130 is configured to evaluate the image 124 to determine a modulation transfer function with respect to the determined axis position and/or at least one further optical parameter of the test object OBJ. The evaluation device 130 may further comprise a sensor, e.g. a CMOS or CCD sensor 131, and an optical unit 132. The evaluation unit can additionally be designed as a focusable system, for example focusable camera, wherein by displacing one or more elements, for example the image sensor, a focusing is adjustable, as indicated by the double-headed arrow 237 in FIG. 2, whereby an additional or alternative possibility for carrying out a focus scan is offered. The optical unit 132 can be designed as a conoscope or telescope, for example. Furthermore, the evaluation unit 130 can be connected to a computing unit, such as a PC. The computing unit is configured to determine an orientation of the main axes of the test object OBJ and associated optical parameters by means of an algorithm, e.g. in the form of software, from the images recorded by the evaluation unit 130. Optionally, the apparatus 100 also comprises at least one movement device 140 according to an example. The movement device 140 is configured to cause a relative movement between the test object OBJ on the one hand and the illumination device 110 and the evaluation device 130 on the other. For this purpose, the movement device 140 is coupled, for example, to the illumination device 110 and/or the evaluation device 130, or to components of the illumination device 110 and/or the evaluation device 130, and/or a holder for the test object OBJ.

FIG. 2 shows a schematic illustration of an example of an apparatus 100 for testing an astigmatic optical test object OBJ. The apparatus 100 in FIG. 2 corresponds to or resembles the apparatus for testing from FIG. 1.

Thus, in the illustration of FIG. 2, of the apparatus 100 the illumination device 110 with the light source 112, the ring-shaped mask element or ring reticle 114 and the collimation optical unit 116, and the evaluation device 130 plus an upper goniometer 250 and a lower goniometer 260 are shown. In addition, FIG. 2 shows the test light 122, the astigmatic optical test object OBJ and the image 124, wherein with respect to the image 124 additionally a tangential focal plane 224T, a sagittal focal plane 224S and, for illustration purposes, four ring contours 225 of the image 124 are drawn with sharp ring contours 226 and blurred ring contours 228. In addition, an axis position (spherical, cylindrical) of the test object OBJ, for example of a spectacle lens, is illustrated, which corresponds to an evaluation direction of an MTF measurement. Both an inclination of the lens axis by 0 degrees and an inclination of the lens axis by 30 degrees are shown here only by way of example. The four ring contours 225 are the result for each of the different focal planes 224S and 224T at the respective axis positions or the respective inclination of the lens axis, here 0° and 30°.

According to an example, the evaluation device 130 of the apparatus 100 is configured to evaluate ring contours 225, 226, 228 of the image 124 which are caused by the ring-shaped mask element 114 and the test object OBJ in order to determine the axis position based on a maximum of the sharpness along the ring contours 225, 226, 228. This represents a first variant or method variant, which is also referred to as detection via ellipsoidal feature recognition. In a focus scan with an astigmatic lens as the test object OBJ, the ring defined by the mask element 114 deforms in the image 124 into an ellipse, which in turn is formed of two semi-axes. The more the spherical component differs from the cylindrical component, the more blurred become the ring contours, see the blurred ring contours 228, along the semi-axes, during the focus scan. The point with the sharpest ring contour 226, where the number of illuminated pixels is the lowest, thus offers conclusions about the position of a semi-axis that corresponds to one of the main axes of the spectacle lens. The second main axis is then directly 90° offset with respect to the first one. The MTF evaluation direction can then be automatically adapted to this axis and trigger a new focus scan.

According to an example, the evaluation device 130 of the apparatus is configured to evaluate ring contours 225, 226, 228 of the image 124 caused by the ring-shaped mask element 114 and the test object OBJ in order to determine the axis position based on a maximum of the light intensity along the ring contours 225, 226, 228. This represents a second variant or method variant, which is also referred to as detection by intensity. Sharp ring contours 226 are accompanied by a higher light intensity. During the focus scan, an intensity evaluation along the ring or the ring contours 225, 226, 228 is performed from the recorded images, whereby the position of the axes can be deduced.

According to an example, the evaluation device 130 of the apparatus is configured to evaluate the image 124 by incrementally changing an evaluation direction of a direction-dependent modulation transfer function in order to determine the axis position based on a maximum of the modulation transfer function. This represents a third variant or method variant, which is also referred to as detection by means of incremental adjustment of the MTF evaluation direction. Traditionally, the evaluation direction of an MTF should be defined in appropriate device settings. When measuring astigmatic spectacle lenses, the axis position of the cylinder determines the evaluation direction of the MTF, which can be between 0 and 180° depending on the centring of the spectacle lens. According to the third variant, this evaluation direction is incrementally changed during a focus scan, wherein larger increments of, for example, 10° or 15° can be used at the beginning. For each recorded frame, the MTF is then evaluated according to the direction. For example, if the MTF° increases with a direction change of 15°, the direction is changed again by 15° or reduced in smaller increments in an iterative process until the maximum MTF is ascertained. The evaluation direction in which the highest MTF is measured also corresponds to one of the main axes of the test specimen or test object OBJ. The second main axis is rotated by 90° relative to the first one. In the case of weakly astigmatic lenses, a through-focus scan, or simply a focus scan, can be dispensed with and the position of the cylinder axis, as described above, can be effected on the basis of one frame. However, a through-focus scan is required for strongly astigmatic lenses, as the image of the ring is too blurred for evaluation.

In other words, FIG. 2 likewise represents the basic idea of at least one example. The measurement can be carried out according to one of the method variants mentioned herein, or the first, second or third variant. The image of the ring reticle or mask element 114 is deformed by the astigmatic effect of the test specimen or test object OBJ into an ellipse or elliptical ring contour 125. Depending on which of the two focal planes 224S or 224T is detected, the features in the different regions of the ellipse change. For example, the number of illuminated pixels, a sharpness criterion, or the measured intensity may change. This allows a conclusion to be drawn as to where the focus planes or the axes of the spectacle lens or test object OBJ lie and how they are oriented in space. A through-focus measurement (focus scan), wherein a through-focus MTF describes how the MTF of an optical system changes when the image plane moves through the focal region for a selected spatial frequency, can be used to observe a feature change across an image series. The focus scan can be performed using the at least one movement device. This can, for example, displace the ring reticle in the illumination device and/or the image sensor in the evaluation device along the respective, optical axis thereof.

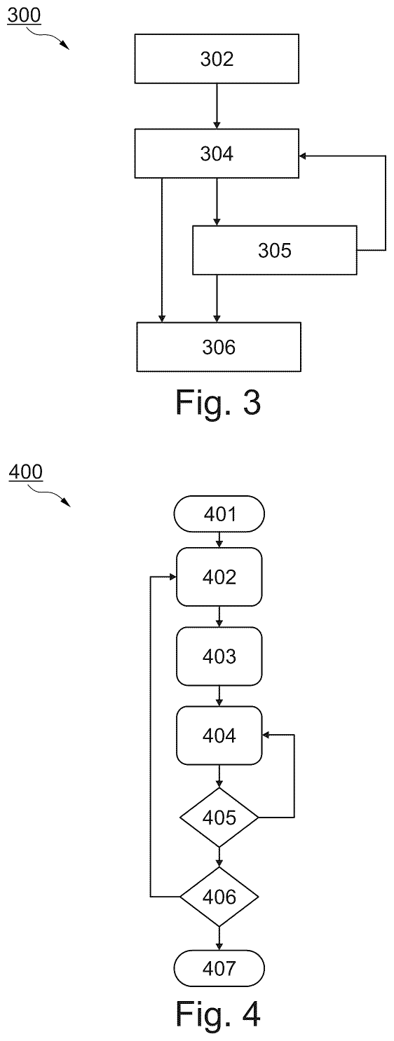

FIG. 3 shows a flow chart of an example of a method 300 for testing an astigmatic optical test object. The method 300 for testing can be carried out in conjunction with or using the apparatus from one of the figures described above. The method 300 for testing comprises an emitting step 302, a recording step 304 and an evaluating step 306.

In emitting step 302, collimated light is emitted to the test object by a collimation optical unit of an illumination device, which has an illuminated ring reticle, which is located in a focal plane of the collimation optical unit, in the form of test light. Subsequently, in recording step 304, an image generated by the test object in response to the test light is recorded using an evaluation device. In turn, in the following evaluating step 306, the image is evaluated using the evaluation device in order to determine at least one axis position and a related, optical imaging parameter of the test object.

According to an example, the method 300 for testing also comprises a causing step 305. In causing step 305, a relative movement between the test object on the one hand and the illumination device and/or the evaluation device on the other, or of components of the illumination device and/or the evaluation device, is caused by using at least one movement device. According to a further example, causing step 305 and recording step 304 are repeatedly carried out iteratively in order to record a plurality of images at different orientations between the test object on the one hand and the illumination device and/or the evaluation device on the other. The plurality of images are subsequently evaluated in evaluating step 306.

FIG. 4 shows a flowchart of an example of a process 400 for testing an astigmatic, optical test object. The process 400 is related to the method for testing from FIG. 3 or a similar method. In FIG. 4, in other words, an iterative measurement of the position of the main axes, or axis position for short, of a test object is shown together with the MTF. The axis position of the test object is determined in accordance with the third variant mentioned above.

The process 400 is started in block 401. In a subsequent block 402, an image is recorded according to or similar to the method of FIG. 3. In a subsequent block 403, an MTF measurement is performed. In a subsequent block 404, an evaluation direction is adjusted by +/−x. In a subsequent decision block 405, a check is performed as to whether the MTF has a maximum value. If so, the process 400 passes to a further decision block 406, in which a check is performed as to whether the focus scan is finished. If so, the process 400 ends with block 407. If it is ascertained in decision block 405 that the MTF does not have a maximum value, the execution jumps back to block 404, in which the evaluation direction is adjusted by +/−x. If it is determined in the further decision block 406 that the focus scan is not finished, the execution jumps back to block 402, in which the image is recorded.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. An apparatus to test an astigmatic optical test object, the apparatus comprising:
an illuminator having a light source, a ring-shaped mask element and a collimation optical unit, the collimation optical unit being formed to emit to the test object light beams of the ring-shaped mask element illuminated by the light source in the form of collimated test light; and
an evaluator, which is configured to record and evaluate an image generated by the test object in response to the test light in order to determine an axis position of the test object and an optical parameter related to the axis position.

2. The apparatus according to claim 1, having at least one movement device, which is configured to cause a relative movement between the test object and the illuminator and/or the evaluator, or of components of the illuminator and/or the evaluator.

3. The apparatus according to claim 1, wherein the evaluator is configured to evaluate the image in order to determine a modulation transfer function with respect to the determined axis position and/or at least one further optical parameter of the test object.

4. The apparatus according to claim 1, wherein the evaluator is configured to evaluate ring contours of the image caused by the ring-shaped mask element and the test object in order to determine the axis position based on a maximum of the sharpness along the ring contours.

5. The apparatus according to claim 1, wherein the evaluator is configured to evaluate ring contours of the image caused by the ring-shaped mask element and the test object in order to determine the axis position based on a maximum of the light intensity along the ring contours.

6. The apparatus according to claim 1, wherein the evaluator is configured to evaluate the image by incrementally changing an evaluation direction of a direction-dependent modulation transfer function in order to determine the axis position based on a maximum of the modulation transfer function.

7. A method for testing an astigmatic optical test object, the method comprising:
emitting, towards the test object, collimated light from a collimation optical unit of an illuminator having a ring-shaped mask element which is approximately located in a focal plane of the collimation optical unit and is illuminable by a light source in the form of test light;
recording an image generated by the test object in response to the test light using an evaluator; and
evaluating the image using the evaluator to determine an axis position of the test object and an optical parameter related to the axis position.

8. The method according to claim 7, further comprising: causing a relative movement between the test object and the illuminator and/or the evaluator, or of components of the illuminator and/or the evaluator using at least one movement device.

9. The method according to claim 8, wherein the causing step and the recording step are repeatedly carried out iteratively in order to record a plurality of images at different orientations between the test object and the illuminator and the evaluator, and wherein the plurality of images are evaluated in the evaluating step.

10. The apparatus according to claim 1, wherein a ring-shaped mask element arranged in the apparatus for testing an astigmatic optical test object.
